(19) United States
(12) Patent Application Publication
(10) Pub. No.: US 2016/0104177 A1
(43) Pub. Date: Apr. 14, 2016

(54) ADMINISTERING AND CONDUCTING SURVEYS, AND DEVICES THEREFOR

(71) Applicant: Brandlogic Corporation, Wilton, CT (US)

(72) Inventors: Hampton Bridwell, Wilton, CT (US); Larry Roth, Rochester, NY (US)

(21) Appl. No.: 14/513,955

(22) Filed: Oct. 14, 2014

(51) Int. Cl. G06Q 30/02

(52) U.S. Cl. CPC G06Q 30/0203

(57) ABSTRACT

A method of administering a survey to an askee, the survey relating to a plurality of events, the method comprising automatically performing steps using a server.

### TECHNICAL FIELD

The present application relates to surveys, and more particularly to techniques and electronic systems for administering and conducting surveys.

### BACKGROUND

Electronic customer surveys are an increasingly popular way of soliciting customer feedback on goods or services. For example, airlines such as JETBLUE sometimes e-mail a personalized customer satisfaction survey to a customer after that customer's flight. The goal of such surveys is twofold: to determine whether there were aspects of the customer's experience that can be improved, and to remind the user about the relevant product or service, or the company offering that product or service.

Survey personalization is commonly used in an effort to engage the customer's attention. Personalization is also used in, e.g., legally mandated “unsubscribe” links in mass emails. Personalization can take the form of changes in content or changes in links. Exemplary personalized “unsubscribe” links can have the URL scheme “https” and the hierarchical part (hereinafter “h-part”)

//example.com/delete?L=DWoffers&E=user %40example.com
or
//www.example.com/unsubscribe.php?param=d3b07384d113edec49eaa6238ad5ff00&sa=D&sntz=1
In these examples, the “E” or “param” fields represent the email address of the subscriber. Throughout the remainder of this disclosure, only the h-parts of exemplary URLs will be given; “https” is the URL scheme for any h-part unless otherwise specified.

Other technologies of personalization have recently come into use. For example, the IBEACON includes a BLUETOOTH (e.g., BLUETOOTH 4.0 LE) transmitter that broadcasts a unique ID. Software running on, e.g., an IPHONE or other computing device can detect the broadcast IDs and take action. This can permit such software to respond to IBEACONs around the user.

### BRIEF DESCRIPTION

However, there is a previously unrecognized problem not solved by prior survey schemes. Surveys taken after completion of a transaction (including events, e.g., a flight) rely on the customer's memory of the transaction, which may become less reliable during the time between the conclusion of the transaction and the customer's taking the survey. In many situations, businesses may use various survey tools to gather feedback from customers, but at a time that is disconnected from the experience the customer had. Surveys generally ask users to rate their experiences for events that have occurred many days of weeks in the past. These surveys typically take between five and 15 minutes to complete. The memory recall burden, combined with the effort required of the customer to answer numerous questions in one period of time, can reduce the accuracy of the survey data. Accordingly, there is a need for ways of, and systems for, improving the survey process to reduce these mental burdens on the customer and improve the accuracy of survey data.

According to an aspect of the invention, there is provided a method of administering a survey to an askee, the survey relating to a plurality of events, the method comprising automatically performing the following steps using a server: receiving a request for survey question(s) via a network, the request including askee identification data; retrieving progress data from a storage device indicating an event of the plurality of events corresponding to the askee identification data; retrieving the survey question(s) corresponding to the indicated event from the storage device transmitting the retrieved survey question(s) via the network in response to the received request; receiving a response to the transmitted survey question(s); storing the received response in association with the askee identification data and the indicated event in the storage device; modifying the progress data in the storage device so that the indicated event no longer corresponds to the askee identification data; and repeating the above steps, wherein the retrieved survey question(s) corresponding to the indicated event after the modifying-progress-data step are different from the retrieved survey question(s) corresponding to the indicated event before the modifying-progress-data step.

Various embodiments advantageously permit asking survey questions relevant to particular events, bringing the time of measurement closer to the occurrence of the event and by reducing the time required to answer survey questions. In some aspects, only 10-15 seconds' worth of questions are asked for each event, and such short groups of questions are asked for each event, in each stage, for an entire interaction between parties. This can permit gathering more accurate survey data and reducing customer frustration.

This brief description is intended only to provide a brief overview of subject matter disclosed herein according to one or more illustrative embodiments, and does not serve as a guide to interpreting the claims or to define or limit scope, which is defined only by the appended claims. This brief description is provided to introduce an illustrative selection of concepts in a simplified form that are further described below in the Detailed Description. This brief description is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an interaction diagram illustrating exemplary methods for administering and conducting surveys of an askee;

FIG. 2 is a flowchart illustrating exemplary methods for administering a survey to an askee;

FIGS. 3 and 4 are flowcharts illustrating steps in exemplary methods for administering a survey to an askee;

FIG. 5 is a flowchart of a exemplary methods of conducting a survey of an askee; and

FIG. 6 is a schematic of an exemplary data-processing system and related components.

The attached drawings are for purposes of illustration and are not necessarily to scale.

### DETAILED DESCRIPTION

Throughout this description, some aspects are described in terms that would ordinarily be implemented as software programs. Those skilled in the art will readily recognize that the equivalent of such software can also be constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

Various aspects herein relate to a survey created or deployed by one or more “surveyors or askers,” e.g., corporations such as JETBLUE or HERTZ, universities, or individuals, to one or more “askees,” e.g., customers, students, employees, members of the public, or people who engage in a service exchange with a business or other asker. The survey can relate to a “journey,” i.e., an extended interaction between the asker and the askee(s). The term “journey” does not require physical motion or travel. Examples of journeys include purchasing a car, attending a conference, and taking a trip. Another example of a journey is “onboarding,” the process of training newly-hired employees in the internal culture of an organization.

For clarity of discussion, journeys are described herein as incorporating a plurality of “events.” For taking a trip by air, exemplary events relevant to the air carrier include comparing travel options, searching for flights and fares, ordering tickets, receiving notification or confirmation emails, traveling to the airport, passing through security, embarking, taxiing, taking off, sitting on the flight for a period of time, purchasing a meal onboard, eating onboard, landing, disembarking, navigating the destination airport, and all of the above for the return flight. The outbound flight and the return flight are examples of “stages,” or groups of related or consecutive events.

In addition to the above examples, a travel experience can involve events relevant to rental-car companies, hotel companies, and tour operators. Askees often do not record observations on all these various events as they happened, reducing accuracy of survey data asked long after the event. Various aspects herein present askees with survey questions relative to an event at or very near to the time that event occurs, reducing the mental burden on the askees and improving survey-data accuracy. This permits askees to, at various times, record their experience with discrete steps in each stage of a journey. This also permits askers to see the answers to survey questions in sooner than is possible in prior schemes, e.g., in real time or near-real-time. This permits askers to change their systems or procedures for the benefit of the askees or other customers or people involved in a journey, or to improve their overall customer experience. A single journey survey can be used for all aspects of a travel experience, or multiple journey surveys can be used (e.g., for flight, car, hotel).

In yet another example, a journey can include a visit to a conference. Events can include conference registration, check-in, the end of each day's sessions, and a followup the day after the conference.

According to various aspects, journey surveys are iterative, ongoing surveys. The survey is broken up into sets of questions that are successively presented to the askee over the course of an interaction. Askee responses are available to the asker over the course of the interaction.

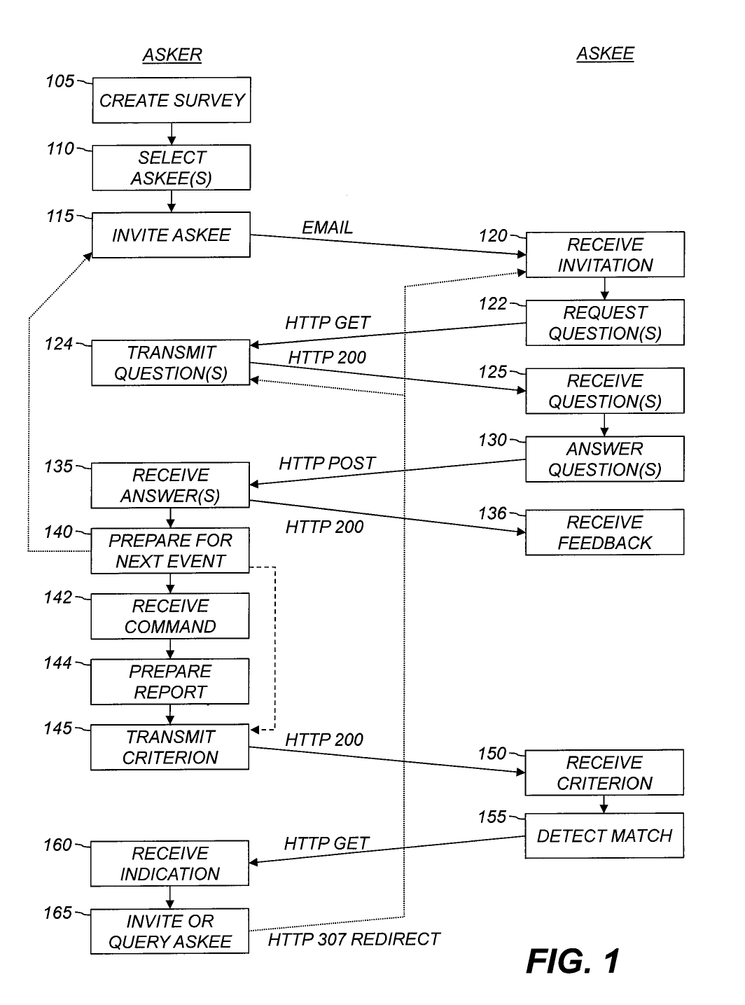

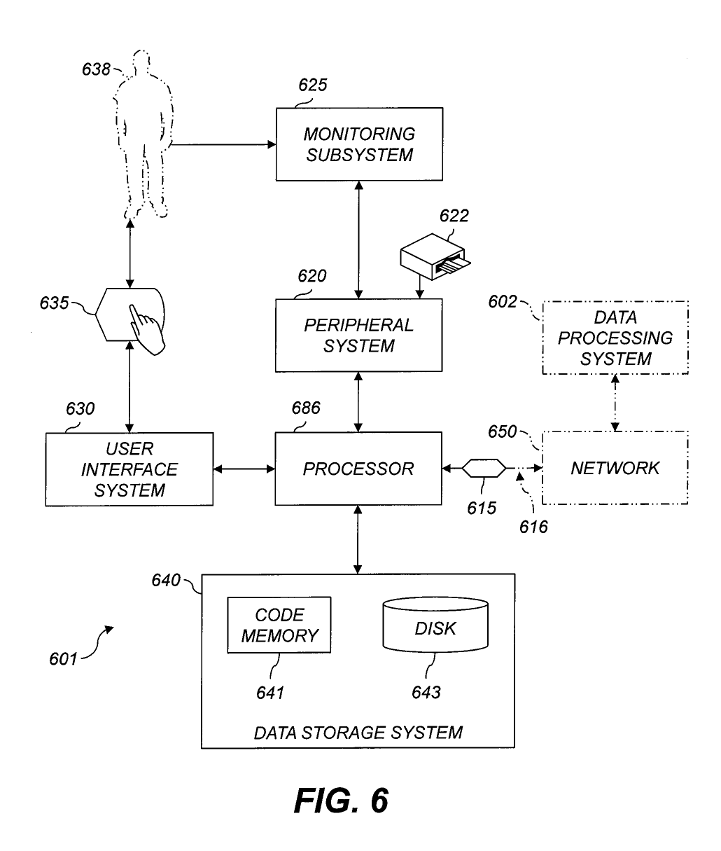

FIG. 1 is an interaction diagram illustrating exemplary methods for administering and conducting surveys of an askee, e.g., a person. The survey relates to a plurality of events. The diagram illustrates the flow of data through cooperating systems, and interactions between asker and askee. Also shown are data produced by some of the steps. Data items are represented graphically as labels on the arrows. Such labels are exemplary only, and are not limiting. Dotted and dashed lines are used for clarity and are not limiting. Actions by the asker are on the left and actions by the askee are on the right. Time flows down the figure. For clarity of explanation, reference is herein made to various components shown in FIG. 6 that can carry out or participate in the steps of exemplary method(s) illustrated. It should be noted, however, that other components can be used; that is, exemplary method(s) shown in FIG. 1 are not limited to being carried out by the identified components.

Various methods described herein can include automatically performing below-described asker or askee steps using respective processors, e.g., one processor in a server operated by or on behalf of the asker(s), and one processor in a client device such as a smartphone or tablet, laptop, or desktop computer. For clarity, the discussion here is phrased in terms of a single asker and a single askee. However, a journey survey can be provided by multiple askers (e.g., an airline and an airport authority), and survey questions can be answered by multiple askees (e.g., spouses).

In various aspects of methods described throughout this application, standard authorization or authentication protocols can be used. However, the use of such protocols is not required. For example, HTTP connections can use SSL encryption (the “https” URL scheme) or not (the “http” URL scheme). Cookies can be used in various aspects, but they are not required. In an example, all state is maintained on the asker's server except for a single survey URL held by the askee. This advantageously reduces the burden on the askee of retaining information. This also advantageously permits the askee to answer different survey questions using different devices at different times. The askee may, for example, answer questions using a smartphone while in an airport and using a laptop computer while in a hotel. In another example, some state is maintained on the askee's device, e.g., in cookies, local files, or data saved by an app.

In step 105, the asker creates a journey survey. This can include a person's entering into a system on a server data of a series of events, e.g., grouped into stages. The person can also provide survey question(s) for each event. Such questions can gauge qualitative or quantitative measures. For example, qualitative questions can solicit a freeform text response; quantitative questions can solicit a choice from a fixed set of options (e.g., one-star through five-star). The data of the events, and the respective question(s), form the journey survey, and can be stored in a database such as an SQL or XML database. Step 105 can also include preparing a plurality of journey surveys.

In various aspects, the journey survey can include optional questions, and the asker's server can select which questions to transmit depending on the askee's previous answers. In various of these aspects, the reporting discussed below with reference to step 144 and FIG. 4 can include aggregating data based on common questions, or providing indications in the report that not all askees answered the same questions.

In various aspects, one or more survey questions or criteria can be modified while a journey survey is being conducted, e.g., to correct errors or resolve ambiguities. In some of these aspects, indications can be provided in a report of which askees answered which versions of which questions under which criteria, or any combination of those factors.

In step 110, the asker selects one or more askee(s) from whom input will be solicited. This can include a person's uploading a list of customer names and email addresses into a database. Each askee can be involved in one or more journey surveys, simultaneously or sequentially. The server initially records that each askee is at the beginning of the survey.

In step 115, the askee(s) are invited. In various aspects, the asker's server automatically produces, and transmits to each askee, an email including a personalized URL corresponding to that askee's particular journey survey. Other ways of transmitting invitations can be used, e.g., text messaging, XMPP or other instant-messenger (IM) communications, physical mail, or TWITTER messages or other social-media communications. In another example, an invitation can be transmitted narrowcast to the askee's smartphone or tablet (“C2D” or “cloud to device”), e.g., via PHONEGAP, APPLE PUSH NOTIFICATION, or GOOGLE CLOUD MESSAGING.

Step 115 can be performed upon request by the asker or an agent, representative, or employee thereof. The asker's server can be communicatively connected with enterprise resource planning (ERP) or customer relationship management (CRM) software or systems, or other internal business software or systems, operated by or on behalf of the asker. In this way, whenever a new customer interaction begins, the asker's server receives information about the askee from the ERP or CRM system, stores the information in the database (step 110), and automatically transmits an invitation to the askee (step 115). This can take place, e.g., when an askee makes a reservation for service or purchases a product.

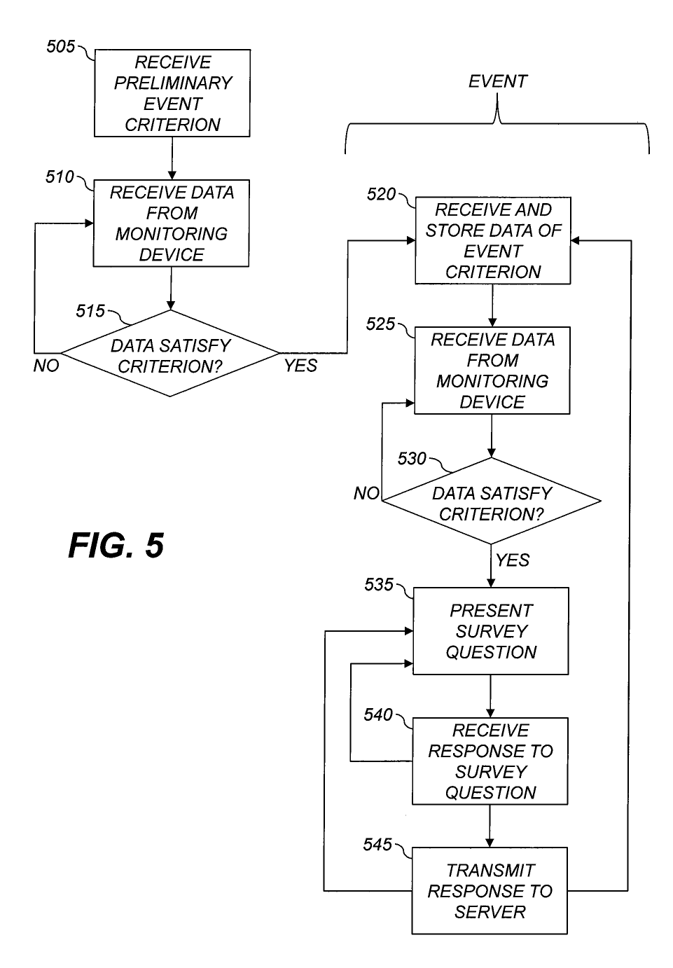

In step 120, the askee receives the invitation, e.g., via email. In an example using GOOGLE CLOUD MESSAGING to transmit the invitation (step 115), an ANDROID app is installed on the askee's smartphone or tablet (“device”). The app is registered to receive notifications via the GOOGLE CLOUD MESSAGING API. The invitation is routed by GOOGLE from the asker's server to the askee's device. The ANDROID operating system on the askee's device activates the app and delivers the invitation to the app. The invitation can include survey question(s) for a first event, or the survey question(s) can be provided separately from the invitation. In various aspects, the app provides the asker's server with context or information about the askee or the askee's activity, e.g., as discussed below with reference to step 530 (FIG. 5).

In step 122, the askee requests survey question(s), e.g., if questions(s) are not included in the invitation. The askee can, e.g., click on the personalized URL in an email or IM invitation, or copy and paste that URL into a Web browser.

In step 124, in an example, the asker's server responds to the request with the questions for the current event to be queried. In another example, the questions themselves are transmitted to the askee or askee's device in advance for storage, and step 124 includes transmitting data identifying certain one(s) of the stored questions.

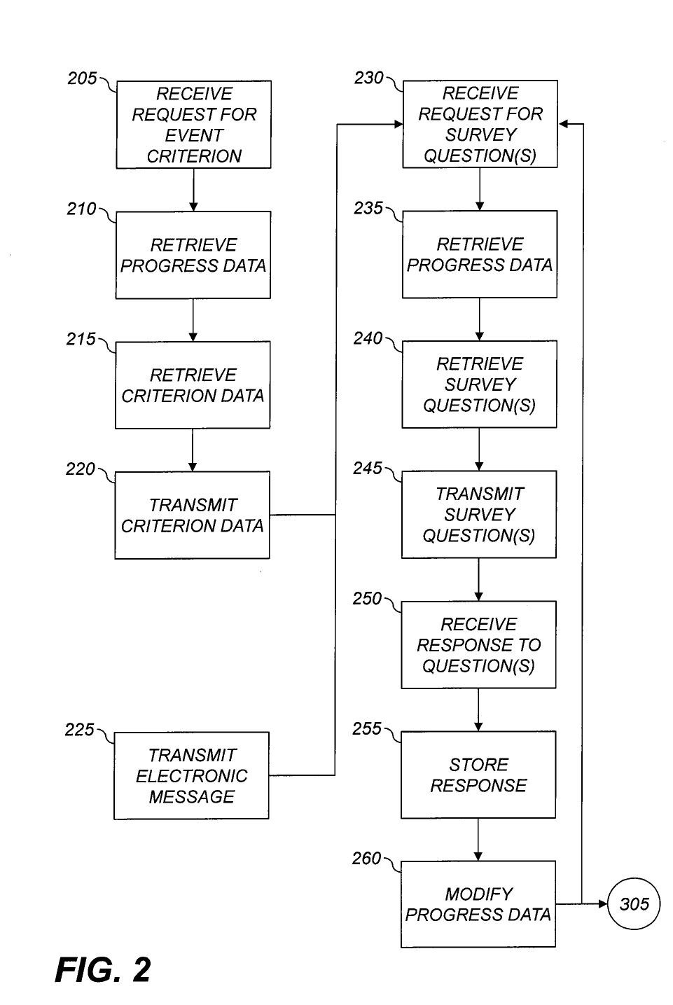

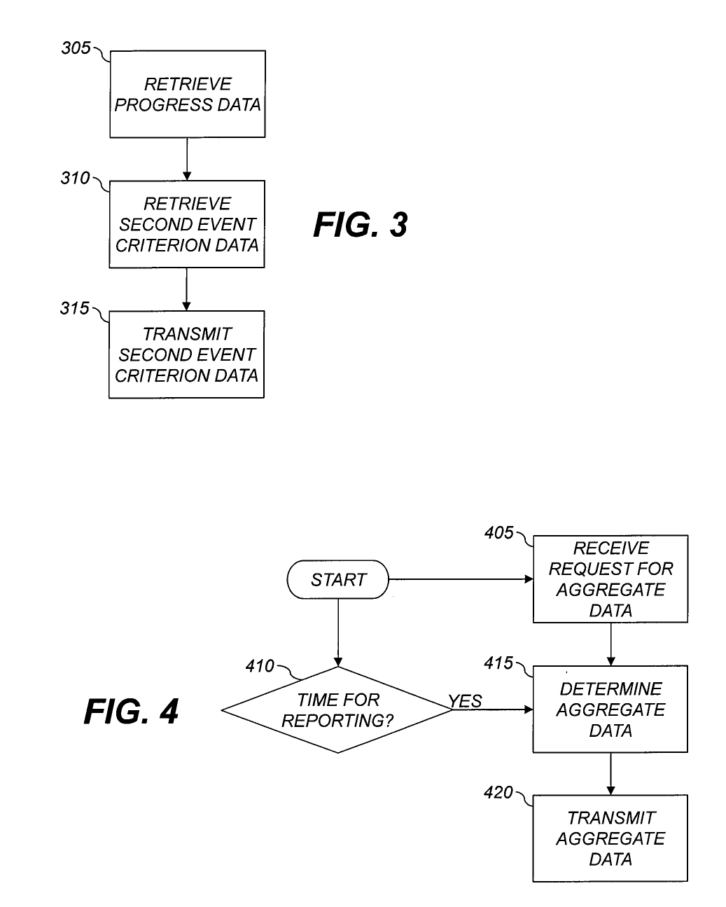

In various aspects, the asker's server can test criteria before responding. For example, the journey survey can store a time limit for event “42,”, e.g., an afternoon session at a conference. The time limit can, e.g., require that survey questions for event “42” be answered after the session to which those questions pertain. If the askee visits the survey URL for event “42” in the morning before the session, the asker's server can return an informational page indicating that no questions are available, instead of returning criteria. An Further examples of criteria are discussed below with reference to steps 145, 150 (FIG. 1); 205, 210, 215, 220 (FIG. 2); and 505, 510, 515, 520, 525, 530 (FIG. 5), and with reference to FIG. 3. All the discussion herein with reference to storage and evaluation of criteria by the askee can also apply to the asker.

In step 125, the askee receives one or more survey question(s) relevant to the current event, e.g., the first event in the journey. The survey questions can be transmitted in an HTTP 200 response body or a C2D message. In aspects using an app, the app can activate when the invitation is received and present the survey questions. The app can display a toast notification and wait for the askee to select the notification before presenting the questions.

In step 130, the askee answers the survey question(s) via the Web browser, app, or other interface, e.g., on a desktop computer, tablet or mobile device. The answers can be transmitted to the asker's server, e.g., via an HTTP POST message issued in response to the askee's selection of a “Submit” button on an HTML form. The transmission to the asker's server can include a request for a criterion or multiple criteria, as discussed below with reference to step 145. Throughout the remainder of this disclosure, references to either “criterion” or “criteria” refer to a single criterion or a plurality of criteria.

In step 135, the asker's server receives the askee's answers and stores them, e.g., in a database. The asker's server can also receive the request for the criterion, as discussed below with reference to step 145.

In an example, the asker's server responds to the answers with a feedback Web page. The feedback page can include, e.g., a “thank you” message or animation. The feedback page can include an HTML <meta refresh> tag (or corresponding response header) that will cause the askee's Web browser to visit the survey URL after a lapse of time. In this way, if the askee leaves the Web browser running, the next survey questions will be presented once available. Responses to requests for the survey URL when no questions are available can include <meta refresh> tag to poll the survey URL periodically until questions are available.

In step 140, the asker's server prepares for the next event. Various aspects of this are described below. In some aspects, as noted by the dotted arrow, the asker's server can repeat steps beginning with step 115. In this way, the asker asks the askee a series of sets of survey questions, one set per event.

In various aspects, a single personalized survey URL is used for a given askee regardless of event. When the askee visits the survey URL and the askee's browser requests corresponding data from the asker's server, the asker's server can respond with questions relevant to the next event about which data is desired. The asker's server can accomplish this by changing the transmitted response body depending on stored information about the next event to be queried. Alternatively, the asker's server can transmit a redirect. For example, in response to an HTTP request for a survey URL having a h-part such as “//www.example.org/survey/joe_blow”, the asker's server can provide a 307 Temporary redirect, e.g., to a question URL having a h-part such as “//www.example.org/survey/joe_blow/42”, based on stored data indicating the next event. In response, askee Joe Blow's Web browser will request the question URL, and the asker's server will respond with the questions relevant to event “42.” The next time askee Joe Blow visits the survey URL, the question URL will have the h-part, e.g., “//www.example.org/survey/joe_blow/43” (event 43). The asker's server can respond to requests for an old question URL, e.g., with h-part “//www.example.org/survey/joe_blow/1”, with an HTTP 307 response redirecting to the appropriate URL or an HTTP 404 Not found response indicating no valid page is found at that address. Other redirect codes such as 302 can be used, or corresponding responses for protocols other than HTTP (and likewise throughout).

In various aspects, the next event to be queried is the event after the event for which the askee most recently submitted survey answers. When the askee submits survey answers for the last event in a particular journey survey, that survey is marked complete. The asker's server can then respond to requests to the survey URL with a redirect to a “survey complete” page.

At any time after the survey is prepared (step 105), the asker (or a representative or employee thereof, and likewise throughout) can request survey data from the asker's server. For example, survey data can be retrieved while askees are in the process of answering surveys or after those surveys are completed. In FIG. 1, this is represented after step 140 at steps 142, 145. Step 140 can also or alternatively be followed by step 145, as indicated by the dashed line.

In step 142, the asker's server (or a reporting server configured to retrieve the survey answers from the asker's server) receives a command to provide a report. The command can include a request from a Web browser for a specific reporting URL, e.g., having a h-part “//www.example.com/survey/report/”. The request can include parameters specifying the type or quantity of data to be included in the report. Other forms of data transmission described above with reference to step 115 can also be used for the command.

In step 144, the asker's (or other) server prepares a report for the requested data and transmits the report via an HTTP 200 response or another form of data transmission described above with reference to step 115. The report can include a dashboard showing aggregated data of the survey. The dashboard can be “realtime,” i.e., can represent all the survey data received from askees as of the time the command is received. The dashboard can also be updated while the asker is viewing the dashboard. For example, the asker's server can maintain an open HTTP or Web Sockets connection to the asker's browser, or the asker's browser can execute JAVASCRIPT or other code to periodically connect to the asker's server using an XMLHTTPRequest or equivalent object. The asker's server can provided updated data values via such a connection when data is changed in or added to the database. In various aspects, the JAVASCRIPT code can respond to click events by the asker on any portion of the aggregated data by retrieving or displaying more data, e.g., the complete dataset used to calculate the clicked-on aggregate data item. AJAX and other related technologies can be used to present and update the report, as can apps and other interface technologies such as mainframe terminals, TELNET connections, or instant messages.

The interactions described above, in various aspects, permit the asker to create a journey survey to engage in data gathering, e.g., via web services (REST, SOAP, or other) over HTTP. The journey survey is useful for capturing qualitative sentiment and quantifiable measurement of discrete customer interactions during events, e.g., across various stages, of a customer journey survey. Aggregate data and discrete data can be displayed on an interactive dashboard via web services over HTTP. Data can be collected via web services via HTTP and the results displayed via web services via HTTP in realtime.

In various aspects, e.g., implementations in which the askee uses a standard Web browser to access the survey and answer questions, the asker provides cues outside the browser to remind the askee to visit the survey URL. For example, at a conference, signs can be posted throughout the venue to remind users to visit their personalized survey URLs. In another example, the asker's server can periodically resend invitations as described above with respect to step 115.

In various aspects, interactions described in steps 145-165 can be performed. These aspects provide more interaction between the asker and the askee with respect to the delineation of events.

In step 145, the asker's server transmits criteria (or a single criterion) to the askee's device. The transmission can be, e.g., via an HTTP 200 response to the askee's submission of survey answers (step 130) and request for the criterion, or via another form of communication such as those described above with reference to step 115. When the criterion is satisfied, one or more corresponding upcoming event(s) are occurring or have occurred. In an example, the journey is a hotel stay. The criterion for an event can be that the askee's device have a GPS location corresponding to the check-in desk of the hotel in which the askee is staying. When the askee arrives at the check-in desk, the criterion will be satisfied and survey questions for the “check in to hotel” event will be provided.

In step 150, the askee (e.g., the askee's device) receives and stores the criterion. In an example, an app on the askee's device receives the criterion and starts timer(s), registers for notification(s), or in other ways prepares to determine when the criterion is satisfied.

In step 155, the askee (e.g., the askee's device) detects a match with the criterion. This can include, e.g., receiving data from a monitoring subsystem 625 (FIG. 6). Any type of data corresponding to the criterion can be used. Once the criterion is satisfied, the askee transmits an indication of the match to the asker's server, e.g., by an HTTP GET to the survey URL. Other ways of transmitting data described above with reference to step 115 can also be used.

In step 160, the asker's server receives the indication of the match. The server can determine which event is next to be queried using stored data or using data transmitted with the indication.

In step 165, the asker's server transmits data of survey question(s) for the appropriate event, or transmits an invitation similar to that discussed above with reference to step 115. In an example, the asker's server responds to the indication with a 307 Redirect to the URL for the next set of questions or for an invitation to the next series of questions. This is indicated by the dotted line, which indicates that after step 165, the askee's device can perform step 120, or the asker's server can perform step 124. Other ways of transmitting data described above with reference to step 115 can also be used.

In various aspects using steps 145-165, the asker can provide a criterion indicating when survey questions are available. The askee's device can monitor the criterion and, when ready, receive survey questions and provide the asker the corresponding survey answers. This can be performed repeatedly over a journey so that appropriate survey questions are asked at each event, as triggered by the corresponding criterion. Further details of these and other aspects are discussed below.

FIG. 2 is a flowchart illustrating exemplary methods for administering a survey to an askee, e.g., a person. The survey relates to a plurality of events. The steps can be performed in any order except when otherwise specified, or when data from an earlier step is used in a later step. In at least one example, processing begins with one of steps 205, 225, and 230. For clarity of explanation, reference is herein made to various components shown in FIG. 6 that can carry out or participate in the steps of the exemplary method. It should be noted, however, that other components can be used; that is, exemplary method(s) shown in FIG. 2 are not limited to being carried out by the identified components. The method can include automatically performing the following steps using a processor, e.g., in the asker's server.

In step 225, before the receiving-request step 230, an electronic message, e.g., an email, is transmitted via a network, e.g., the Internet. The electronic message includes a hyperlink (the survey URL) including askee identification data (e.g., “joe_blow” in the example discussed above with reference to step 140, FIG. 1). Examples of askee identification data include user names or nicknames, askee numbers or other database identifiers, and digital certificates. The electronic message can be an invitation as discussed above with reference to step 115 (FIG. 1).

In step 230, a request for survey question(s) is received via the network, e.g., the Internet. The request includes askee identification data. This step can include receiving network data corresponding to access of the hyperlink survey URL indicated in the email of step 225. Such network data can include, e.g., an HTTP/1.1 request header such as given in Table 1. The request can be received or formatted as discussed above with reference to step 124 (FIG. 1).

TABLE 1
exemplary HTTP request

GET /survey/joe_blow HTTP/1.1<CR> <LF>
Host: www.example.com<CR> <LF>
<CR> <LF>

In step 235, progress data are retrieved from a storage device, e.g., disk 643 (FIG. 6). The progress data indicate an event of the plurality of events corresponding to the askee identification data. E.g., the asker's server can store a database table indicating that the next event to be queried for askee “joe_blow” is event “42.” The progress data in this example include the event number, “42.”

In step 240, the survey question(s) corresponding to the indicated event are retrieved from the storage device. The survey question(s) can be stored in a database indexed by event number, as discussed above with reference to step 105 (FIG. 1).

In step 245, the retrieved survey question(s) are transmitted via the network in response to the received request. They can be transmitted to a Web browser or an app, as noted above with reference to step 125 (FIG. 1).

In step 250, the processor (e.g., on the asker's server) receives a response to the transmitted survey question(s). This can be as discussed above with reference to step 135 (FIG. 1).

In step 255, the processor stores the received response in association with the askee identification data and the indicated event in the storage device. In step 260, modifying the progress data in the storage device so that the indicated event no longer corresponds to the askee identification data. These steps can include processing described above with reference to steps 135, 140 (FIG. 1). For example, the processor can update a “next-event” database record for askee “joe_blow” to refer to event number “43” instead of “42”.

Steps 255, 260 complete server processing for survey question(s) corresponding to a single event, according to various aspects. In various aspects, step 260 can be followed by step 305 (FIG. 3), discussed below.

In various aspects, some or all of the above-described steps, e.g., steps 205, 210, 215, 220, or steps 230, 235, 240, 245, 250, 255, and 260, can be repeated one or more time(s) for subsequent event(s). When step 240 is repeated after the modifying-progress-data step 260, the retrieved survey question(s) corresponding to the indicated event are different from the retrieved survey question(s) corresponding to the indicated event before the modifying-progress-data step 260. In this way, appropriate survey question(s) are provided for each event as the askee proceeds through a journey.

In various aspects, the server is configured to administer a survey for which responses are collected by, e.g., a device capable of checking the criterion. In these aspects, steps 205, 210, 215, 220 are performed before receiving the request for survey question(s) (step 230).

In step 205, a request for an event criterion is received, e.g., from the askee's smartphone or tablet. The request includes the askee identification data (e.g., “joe_blow”). This can be as described above with reference to step 135 (FIG. 1).

In step 210, the processor retrieves the progress data as described above with reference to step 235. Step 210 is shown separately from step 235 for the sake of clarity; steps 210 and 235 can include the same processing or different processing.

In step 215, first event criterion data corresponding to the indicated event are retrieved, e.g., from the database. This can be as described above with reference to step 145 (FIG. 1). Examples of criteria are dates, times, timestamps, locations, motions, and others discussed below with reference to FIG. 5, e.g., step 530. A “timestamp” is a combination of a date and a time.

In step 220, the first event criterion data are transmitted via the network, e.g., to the askee's smartphone or tablet, in response to the criterion request. This can be as described above with reference to step 145 (FIG. 1).

As described above with reference to steps 150, 155 (FIG. 1) and below with reference to steps 520, 525, 530 (FIG. 5). the askee's device can wait for the criterion to be satisfied. The askee's device can then request survey questions, at which point processing resumes with step 230.

FIG. 3 is a flowchart illustrating steps in exemplary methods for administering a survey to an askee, e.g., a person. These steps can be used, e.g., with methods including steps 205-220 (FIG. 2). As noted above, the steps can be performed in any order except when otherwise specified, and exemplary step(s) or method(s) shown are not limited to being carried out by any identified components. The methods can include automatically performing the following steps using a processor, e.g., in the asker's server. Step 305 can be performed, e.g., after modifying-progress-data step 260 (FIG. 2).

In step 305, the retrieving-progress-data step 235 (FIG. 2) is repeated to retrieve data corresponding to the askee identification data. Step 305 is shown separately from step 235 for the sake of clarity; steps 305 and 235 can include the same processing or different processing. Since retrieval is performed after the modifying-progress-data step 260, the retrieved data indicate a second event of the plurality of events. For example, step 235 can retrieve an indication of event “42,” and step 305 can retrieve an indication of event “43.”

In step 310, after the progress data are retrieved, second event criterion data corresponding to the indicated second event are retrieved. This can be as described above with reference to step 215.

In step 315, the second event criterion data are transmitted via the network. This can be as discussed above with reference to step 220.

FIG. 4 is a flowchart illustrating steps in exemplary methods for administering a survey to an askee, e.g., a person. As noted above, the steps can be performed in any order except when otherwise specified, and exemplary step(s) or method(s) shown are not limited to being carried out by any identified components. The methods can include automatically performing the following steps using a processor, e.g., in the asker's server. Processing can begin with or be triggered by step 405 or step 410.

In step 405, a request for aggregate data, or a command to produce aggregate data, is received. The request can be received via a Web browser or other interface, e.g., as discussed above with reference to step 142.

In decision step 410, it is determined, e.g., by the processor on the asker's server, whether it is time for reporting. This determination can include determining whether a countdown timer has expired; determining whether the current date, time, or timestamp (date/time) is at or after a selected next-report date, time, or timestamp, respectively; or determining whether the current date, time, or timestamp is within a scheduled-reporting window. This determination can be made in addition to or instead of the receipt in step 405. For example, reports can be provided on request (step 405), or periodically or on a schedule (step 410), in any combination.

In step 415, in response to the received request or determination that it is time for reporting, aggregate data are determined using the stored received responses. This can be as described above with reference to step 144 (FIG. 1). The determining-aggregate-data step 415 can include producing image data of a visual representation of the aggregate data, e.g., a histogram of responses to a quantitative survey question.

In step 420, the aggregate data are transmitted via the network, e.g., to the Web browser of the asker or an agent or employee thereof. This can be as described above with reference to step 144 (FIG. 1).

Various aspects described above with reference to FIGS. 2-4 and below with reference to FIG. 6 can be used on an asker's survey to administer a journey survey. Various aspects described below with reference to FIGS. 5, 6 can be used to conduct a journey survey, e.g., on an askee's computing device. Methods described herein with reference to FIGS. 2-4, 6 (administering survey) can be used together with methods described below with reference to FIGS. 5, 6 (conducting survey) to provide an interaction between asker and askee such as that illustrated in FIG. 1. Alternatively, methods described herein with reference to FIGS. 2-4, 6 can be used independently of methods described below with reference to FIG. 5, 6, or methods described below with reference to FIG. 5, 6 can be used independently of methods described above with reference to FIGS. 2-4, 6.

FIG. 5 is a flowchart of exemplary methods of conducting a survey of an askee, e.g., a person. The survey relating to a plurality of events. As noted above, the steps can be performed in any order except when otherwise specified, and exemplary step(s) or method(s) shown are not limited to being carried out by any identified components. The methods can include automatically performing the following steps using a processor 686 (FIG. 6), e.g., in the askee's computer, tablet, or smartphone. Processing can begin with step 505 or step 520. As discussed below, when a first event criterion is satisfied (steps 520, 525, 530), survey questions relevant to the first event can be presented to the askee (step 535).

In step 505, in various aspects, before survey question(s) are presented to the askee with respect to the first event criterion (as discussed below with reference to step 535), data of a preliminary event criterion are received from a server. The data of the preliminary event criterion are stored in a memory. This can be as discussed above with reference to step 150; the criterion can be as discussed above with reference to step 145.

In step 510, data of one or more kinds are received from a monitoring subsystem 625 (FIG. 6). This can be as discussed above with reference to step 155 or as discussed below with reference to steps 525, 530. Examples of different kinds of data are discussed below with reference to step 530. Different kinds of data can be received simultaneously or sequentially.

In decision step 515, the processor 686 automatically waits until the data satisfy the preliminary event criterion. This can be as discussed above with reference to step 155. If the data satisfy the preliminary criterion, the method proceeds to step 520. If the data do not satisfy the preliminary criterion, the method returns to step 510. In this way, the processor 686 (e.g., in the askee's device) waits until the preliminary event criterion is satisfied.

In an example, the journey is a hotel stay. The first event is detected when the askee is leaving the check-in counter, as determined from GPS data. The preliminary event criterion can include the askee's presence at the check-in counter for more than 30 s. This advantageously reduces the likelihood of detecting the first event when the askee is merely passing by the check-in counter.

Steps 505, 510, 515 can be omitted, and processing can begin at step 520. Alternatively, steps 505, 510, 515 can be performed one or more times, sequentially or in parallel. In this way, the processor 686 can test for any number or arrangement of preliminary event criteria before proceeding to the first event criterion.

In step 520, data of a first event criterion are received from a server and the data of the first event criterion are stored in a memory. The memory can be, e.g., a random-access memory (RAM) or Flash or other rewritable nonvolatile memory. This can be as discussed above with reference to step 150; the criterion can be as discussed above with reference to step 145. In various aspects, step 520 further includes receiving a second event criterion, as is discussed below with reference to step 545. In general, any number of event criteria ≧1 can be received in step 520.

In step 525, data of one or more kinds are received from a monitoring subsystem 625. This can be as discussed above with reference to steps 155 (FIG. 1), 510.

In step 530, the processor 686 automatically determines whether the data satisfy the first event criterion. This can be as discussed above with reference to step 155. If the data satisfy the first event criterion, the method proceeds to step 535. If the data do not satisfy the first event criterion, the method returns to step 525. In this way, the processor 686 (e.g., in the askee's device) waits until the first event criterion is satisfied.

An event can be defined by proximity to a transmitter such as an IBEACON. Such events can be useful for events related to, e.g., presence at a check-in counter or other service location. According to various aspects, therefore, the first event criterion relates to proximity to a wireless transmitter having a specified identification value. The wireless transmitter can be an IBEACON, a WIFI access point, a commercial or amateur radio station transmitter, or another device that transmits an identification value (“ID”) that can be detected by a monitoring subsystem 625 (FIG. 6). The ID can be, e.g., a GUID, UUID, broadcast frequency, or spread-spectrum transmission chip or frequency sequence. Monitoring subsystem 625 includes a receiver configured to detect identification value(s) broadcast by wireless transmitter(s) and provide the detected identification value(s) as the data (step 525). Processor 686 can proceed to step 535 when the specified identification value is detected by monitoring subsystem 625. In an example on a smartphone or similar device, the operating system running on the device can route received IDs (“pings”) to an app that is registered to receive those pings, and the software of the app can direct processor 686 in carrying out steps 535, 540, 545.

An event can be defined more specifically by approach to such a transmitter. According to various of the above aspects, therefore, the processor 686 (FIG. 6) is configured to determine that the data satisfy the first event criterion if a newly-detected one of the detected identification value(s) (IDs) matches the specified identification value. For example, when a desired ID is first detected, processor 686 can proceed to step 535. Likewise, an event can be defined more specifically by departure from such a transmitter. According to various of the above aspects, therefore, processor 686 is configured to determine that the data satisfy the first event criterion if one of the detected identification value(s) matches the specified identification value at a first time, and none of the detected identification value(s) matches the specified identification value at a second time later than the first time. For example, when a desired ID is detected, and then later is no longer detected, processor 686 can proceed to step 535.

An event can be defined by a time of day. For example, survey questions about a meeting can be asked at or after the scheduled end time of that meeting. According to various of the above aspects, therefore, the first event criterion includes a selected aim time or timestamp. Monitoring subsystem 625 is configured to provide a current time or timestamp as the data. For example, monitoring subsystem 625 can include a hardware realtime clock (RTC) or a time-signal receiver, e.g., a radio tuned to WWVB and a corresponding decoder. Processor 686 is configured to determine that the data satisfy the first event criterion if the current time or timestamp is within a selected tolerance of the aim time or timestamp, respectively. In some aspects, e.g., those in which processor 686 in the askee's device sleeps periodically, or an app is only activated periodically, processor 686 can determine that the data satisfy the first event criterion if the current time or timestamp is after the aim time or timestamp, respectively.

An event can be defined by location. For example, survey questions about a shopping mall can be asked when the askee is in the shopping mall. According to various aspects, therefore, the first event criterion includes an aim location, e.g., latitude and longitude coordinates. The monitoring subsystem 625, e.g., a GPS, GLONASS, or eLORAN receiver, or a WIFI, cell-phone tower, or other triangulator, is configured to provide a current location as the data. Monitoring subsystem 625 can include hardware or algorithms to triangulate from IBEACONS based on signal strength of the received IDs. The current location can be the current location of the askee's smartphone, tablet, or other device, and will be relevant if that device is near the askee. The processor 686 is configured to determine that the data satisfy the first event criterion if the current location is within a selected tolerance of the aim location. The current tolerance can be provided as part of the event criterion, or can be preselected by the asker or askee. In an example, the processor determines that the data satisfy the first event criterion if the current location is within a 100 m radius of 35° 36′ 46.71″ N, 138° 56′ 34.33″ E. In various aspects, the aim location includes a spatial region of interest, e.g., a polygon defined by the latitude and longitude of each corner. If the current location is within the polygon, processor 686 proceeds to step 535.

An event can be defined by a location and a time. According to various aspects, therefore, the first event criterion includes both an aim timestamp and a spatial region of interest or aim location, as noted above. Monitoring subsystem 625 provides both time and location information, as noted above. Processor 686 determines that the first event criterion is satisfied if the askee (or askee's device) is in the spatial region of interest at a time or timestamp corresponding to (e.g., at, before, or after) the aim timestamp. In an example, if the askee arrives at a restaurant before the lunch hour, survey questions about breakfast can be asked. If the askee arrives at the same restaurant during the lunch hour, survey questions about lunch can be asked.

An event can be defined by a property of the environment sensed by monitoring subsystem 625, e.g., temperature, relative humidity, or light level. Monitoring subsystem 625 can include appropriate sensors and the criterion can include ranges or thresholds for the properties. Processor 686 can proceed to step 535 if the data fall within the ranges or thresholds.

An event can be defined by an artifact in the environment sensed by monitoring subsystem 625, either autonomously or in response to an action by the askee. For example, the askee can photograph a QR or other barcode using a smartphone, tablet, or other device. The monitoring subsystem 625 can include a digital camera and software or other processing resources to locate an decode the barcode in an image captured with the digital camera. The data can include a value sought in the scanned barcode, or simply an indication that a barcode has been scanned. Processor 686 can proceed to step 535 when a barcode has been scanned or when a barcode including the value sought has been scanned.

An event can be defined by a motion. For example, when the accelerometer in the askee's device indicates that the askee is running (forward motion together with a periodic vertical motion component at a reasonable human jogging pace), survey questions about jogging shoes can be asked. According to various aspects, therefore, the monitoring subsystem 625 is configured to provide a current motion of the monitoring subsystem 625. The data of the current motion can include a series of locations and timestamps (e.g., measured using a GPS receiver), a vector indicating direction of motion, an acceleration or velocity (e.g., measured using an accelerometer), or a flag bit indicating that motion faster than a threshold is occurring or that the askee (or askee's device) is substantially stationary. The first event criterion (steps 520, 525, 530) includes an aim motion. Processor 686 proceeds to step 535 if, e.g., the correlation between a vector of sampled accelerations included in the criterion and such a vector included in the data exceeds a selected threshold, or if the direction of motion falls within a selected range of directions (e.g., NE, 22.5°-67.5°).

An event can be defined more specifically by a motion in addition to a location. For example, when the askee's device (and, presumably, the askee) move away from a kiosk or vending machine, the asker can transmit survey questions about the askee's experience using the kiosk or vending machine. According to various aspects, therefore, the monitoring subsystem 625 is configured to provide the data including a current location of the monitoring subsystem 625, as described above, and a current motion of the monitoring subsystem 625. The data of the current motion can include a series of locations and timestamps (e.g., measured using a GPS receiver), a vector indicating direction of motion, an acceleration or velocity (e.g., measured using an accelerometer), or a flag bit indicating that motion faster than a threshold is occurring or that the askee (or askee's device) is substantially stationary. The preliminary event criterion described above with reference to steps 505, 510, 515 includes an aim location. The first event criterion (steps 520, 525, 530) includes an aim motion.

An event can be defined by any combination of the above exemplary types of events, sequentially or concurrently in any combination. Examples include a motion followed by a location, two different motions in series, and the scan of a QR code followed by a motion. Another example includes a location concurrently with both a timestamp and presence of a specific IBEACON (e.g., visiting a specific counter at a specific store during a specific time of day).

As noted above, once the data satisfy the criterion in decision step 530, the method proceeds to step 535.

In step 535, a first survey question (or question(s)) corresponding to the askee is presented via an output device. The output device can, e.g., include an electronic display, a speech synthesizer, a speaker or other audio output, e.g., to play an audio recording, or a tactile stimulus, e.g., a refreshable braille display or braille terminal. This can be as described above with reference to steps 120, 122, 125, 130 (FIG. 1). As noted above, the askee's device can present a toast or other notification before or while presenting the survey questions. Exemplary notifications include beeps, vibrations, the playback of specified ringtones, and the blinking of LEDs.

In step 540, a response to the first survey question is received, e.g., from the askee, via an input device. The input device can include, e.g., a touchscreen, keypad, number pad, radio-triangulation stylus, or e-paper stylus or pad. This can be as described above with reference to step 130 (FIG. 1).

In step 545, the response to the survey question is transmitted to the server, e.g., to the asker's server. This can be as described above with reference to step 130 (FIG. 1). In various aspects, steps 535, 540, 545 can be repeated for each of a plurality of survey questions corresponding to the first event criterion. Any number ≧1 of survey questions can be presented at once. For example, three survey questions can be presented on a touchscreen together in step 535, and steps 535, 540, 545 can be repeated three times for a total of nine questions. Alternatively or additionally, steps 535 and 540 can be repeated for a plurality of question(s) or groups thereof and the received responses can be batched. Step 545 can then include transmitting the batched responses in one transaction.

In various aspects, after step 545, the next step is step 520. In this way, steps 520, 525, 530, 535, 540, 545 are repeated for each event, i.e., for each of a plurality of event criteria. Each time step 520 is reached, data are received of a second or subsequent event criterion, which can be the same as the first event criterion or different therefrom. The received data are used in place of the first event criterion, and a second or subsequent survey question (the same as or different from any foregoing survey questions) corresponding to the askee is used in place of the first survey question. In various aspects, an app running on the askee's device requests the criteria for the entire journey at the beginning of the survey and stores all the criteria. In other aspects, the app receives the criteria one at a time. As noted above, in aspects in which step 520 includes receiving a second event criterion, the method can include retrieving the second event criterion from the memory when step 520 is repeated, instead of receiving the second event criterion after performing step 545. In general, any number ≧1 of event criteria can be received at a time and stored, and step 520 can include any combination of receiving event criteria and retrieving stored event criteria each event, i.e., each time steps 520-545 are repeated.

FIG. 6 is a schematic of an exemplary data-processing system 601 for analyzing data and performing other steps described herein, and related components. The system 601 includes a processor 686, a peripheral system 620, a user interface system 630, and a data storage system 640. The peripheral system 620, the user interface system 630 and the data storage system 640 are communicatively connected to the processor 686. Processor 686 can be communicatively connected to network 650 (shown in phantom), e.g., the Internet or a leased line, as discussed below. The asker's server and the askee's device referred to above, e.g., in FIG. 1, can each include one or more of systems 686, 620, 630, 640, and can each connect to one or more network(s) 650. Processor 686, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 686 can implement processes of various aspects described herein. Processor 686 and related components can, e.g., carry out processes supporting the interaction described in FIG. 1, or processes represented in FIGS. 2-5. In various aspects, system 601 can communicate, e.g., via network 650, with a data processing system 602, which can include the same types of components as system 601 but is not required to be identical thereto. Each system 601, 602 can execute corresponding computer program instructions to perform processes described above.

In an example, data-processing system 601 is embodied in a server or other computer belonging to or operated for the benefit of the asker. A disk 643 can store the database of criteria and questions referred to above with reference to FIG. 1. The system 601 can communicate with askees' devices or other systems 602 via communication interface 615 and network 650. The system 601 can provide reports or data, e.g., as discussed above with reference to step 144 (FIG. 1) or FIG. 4, via user interface system 630, network interface 615, or peripheral system 620.

In another example, data-processing system 601 is embodied in a computer the asker uses to access survey data. This computer can be the asker's server or a separate computer, and can include multiple monitors in user interface system 630.

In another example, data-processing system 601 is embodied in a laptop computer, smartphone, tablet computer, desktop computer, or other computer belonging to or operated for the benefit of askee 638. The data processing system 601 includes the data storage system 640 or another storage device configured to store data of an event criterion. Monitoring subsystem 625 is connected to processor 686 via peripheral subsystem 620. Monitoring subsystem 625 is configured to provide monitoring data of a type specified in the event criterion. For example, monitoring subsystem 625 can record information about askee 638 such as the location or movement of askee 638.

In various aspects, monitoring subsystem 625 includes a processor, software, or other processing resources to provide data, e.g., as described above with reference to step 530 (FIG. 5). In an example, monitoring subsystem 625 can include or be connected to an accelerometer, digital camera, or other device for sensing a property of the environment or world around monitoring subsystem 625. In another example, monitoring subsystem 625 can include software running on processor 686 and operative to, e.g., report dates, times, or timestamps; report uptimes and other parameters of operation of processor 686; or process packets received from network 650. The software in monitoring subsystem 625 can await particular transmissions or types of transmissions, e.g., notifications from ERP or CRM systems as discussed above with reference to step 115 (FIG. 1). In this way, laptops or other computers that lack external sensors can perform steps relating to the askee as shown in FIG. 1. Monitoring subsystem 625 can be embodied in an asker's device or an askee's device. In an example, an asker's server includes monitoring subsystem 625 to test criteria for timestamp before transmitting survey questions to the askee's device, as discussed above with reference to step 124 (FIG. 1_.

Processor 686 is coupled to monitoring subsystem 625 and configured to automatically determine whether the monitoring data satisfy the event criterion indicated by the stored data and perform subsequent process steps if so. Processor 686 is configured to respond to a determination that the monitoring data satisfy the event criterion by presenting a first survey question corresponding to the askee via an electronic display such as touchscreen 635. Touchscreen 635 can be connected to processor 686 via user interface system 630 or via network 650. Processor 686 is further configured to receive a response to the first survey question, e.g., from the askee, via an input device such as a touch sensor associated with the electronic display in touchscreen 635.

Processor 686 is further configured to transmit the response via network 650. Processor 686 is further configured to receive data of a second event criterion different from the event criterion via network 650, and to store the data of the second event criterion in place of the data of the first event criterion. The term “in place of” does not require that the data of the first event criterion be overwritten or destroyed. Processor 686 stores the data of the second event criterion so that processor 686 will determine whether subsequent data from monitoring subsystem 625 satisfy the second event criterion instead of the first event criterion.

In view of the foregoing, various aspects provide ways of administering or conducting journey surveys. A technical effect of various aspects is to sense a property of the environment around a device operated by the askee, determine that an event has occurred, and interact with the asker's server to provide survey questions relevant to the event. A further technical effect of various aspects is to present a visual representation of relevant survey questions on an electronic display, or to present an auditory representation of the relevant survey questions via an audio output.

Another example of a device that can be used by askees to answer questions is a kiosk (not shown) including a data processing system 601. Processor 686 in the kiosk can prompt an askee via user interface system 630 for the askee's email address or other identifying information such as username (e.g., “joe_blow”). In an example, the askee can insert a memory card, USB stick, or other tangible, non-transitory computer-readable storage medium into a reader 622 coupled to peripheral system 620. Processor 686 then retrieves the identifying information from the storage medium. In yet another example, processor 686 can receive the identifying information wirelessly from an askee's device, e.g., via BLUETOOTH, WIFI, or IrDA, or badge or other smart tag, e.g., via RFID or barcode scanner. Once processor 686 has received or retrieved identifying information, processor 686 can access the appropriate survey URL via a Web browser to present questions and receive and transmit answers via touchscreen 635, as discussed above. Alternatively, the kiosk can have a fixed number of buttons or softkeys in user interface system 630 and a printed card or other display of questions and answers associated with the buttons. The kiosk can receive answers via presses of the buttons and transmit them to the asker's server.

In various aspects, whether data-processing system 601 is embodied on behalf of the asker or on behalf of the askee, processor 686 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 620, user interface system 630, and data storage system 640 are shown separately from the processor 686 but can be stored completely or partially within the processor 686.

The peripheral system 620 can include one or more devices configured to provide digital content records to the processor 686. For example, the peripheral system 620 can include or be connected to digital still cameras, digital video cameras, cellular phones, accelerometers, location-detecting devices, or other data processors. The processor 686, upon receipt of digital content records from a device in the peripheral system 620, can store such digital content records in the data storage system 640.

The user interface system 630 can convey information in either direction, or in both directions, between a user (e.g., an askee 638) and the processor 686 or other components of system 601. The user interface system 630 can include a mouse, a keyboard, another computer (connected, e.g., via a network or a null-modem cable), or any device or combination of devices from which data is input to the processor 686. The user interface system 630 also can include a display device, a processor-accessible memory, or any device or combination of devices to which data is output by the processor 686. The user interface system 630 and the data storage system 640 can share a processor-accessible memory.

In various aspects, processor 686 includes or is connected to communication interface 615 that is coupled via network link 616 (shown in phantom) to network 650. For example, communication interface 615 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 615 sends and receives electrical, electromagnetic or optical signals that carry digital or analog data streams representing various types of information across network link 616 to network 650. Network link 616 can be connected to network 650 via a switch, gateway, hub, router, or other networking device.

Processor 686 can send messages and receive data, including program code, through network 650, network link 616 and communication interface 615. For example, a server can store requested code for an application program (e.g., a JAVA applet) on a tangible non-volatile computer-readable storage medium to which it is connected. The server can retrieve the code from the medium and transmit it through network 650 to communication interface 615. The received code can be executed by processor 686 as it is received, or stored in data storage system 640 for later execution.

Data storage system 640 can include or be communicatively connected with one or more processor-accessible memories configured to store information. The memories can be, e.g., within a chassis or as parts of a distributed system. The phrase “processor-accessible memory” is intended to include any data storage device to or from which processor 686 can transfer data (using appropriate components of peripheral system 620), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 640 can be a tangible non-transitory computer-readable storage medium, i.e., a non-transitory device or article of manufacture that participates in storing instructions that can be provided to processor 686 for execution.

In an example, data storage system 640 includes code memory 641, e.g., a RAM, and disk 643, e.g., a tangible computer-readable rotational storage device such as a hard drive. Computer program instructions are read into code memory 641 from disk 643. Processor 686 then executes one or more sequences of the computer program instructions loaded into code memory 641, as a result performing process steps described herein. In this way, processor 686 carries out a computer implemented process. For example, steps of methods described herein, blocks of the flowchart illustrations or block diagrams herein, and combinations of those, can be implemented by computer program instructions. Code memory 641 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 686 (and possibly also other processors), to cause functions, acts, or operational steps of various aspects herein to be performed by the processor 686 (or other processor). Computer program code for carrying out operations for various aspects described herein may be written in any combination of one or more programming language(s), and can be loaded from disk 643 into code memory 641 for execution. The program code may execute, e.g., entirely on processor 686, partly on processor 686 and partly on a remote computer connected to network 650, or entirely on the remote computer.

The invention is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A method of administering a survey to an askee, the survey relating to a plurality of events, the method comprising automatically performing the following steps using a server:
a) receiving a request for survey question(s) via a network, the request including askee identification data;
b) retrieving progress data from a storage device indicating an event of the plurality of events corresponding to the askee identification data;
c) retrieving the survey question(s) corresponding to the indicated event from the storage device;
d) transmitting the retrieved survey question(s) via the network in response to the received request;
e) receiving a response to the transmitted survey question(s);
f) storing the received response in association with the askee identification data and the indicated event in the storage device;
g) modifying the progress data in the storage device so that the indicated event no longer corresponds to the askee identification data; and
h) repeating the above steps, wherein the retrieved survey question(s) corresponding to the indicated event after the modifying-progress-data step are different from the retrieved survey question(s) corresponding to the indicated event before the modifying-progress-data step.

2. The method according to claim 1, further including, before receiving the request for survey question(s):
a) receiving a request for an event criterion, the request including the askee identification data;
b) performing the retrieving-progress-data step;
c) retrieving first event criterion data corresponding to the indicated event; and
d) transmitting the first event criterion data via the network in response to the criterion request.

3. The method according to claim 2, further including, after the modifying-progress-data step, repeating the retrieving-progress-data step to retrieve data indicating a second event of the plurality of events corresponding to the askee identification data after the modifying-progress-data step, subsequently retrieving second event criterion data corresponding to the indicated second event, and transmitting the second event criterion data via the network.

4. The method according to claim 1, further including receiving a request for aggregate data and, in response to the received request, determining aggregate data using the stored received responses and transmitting the aggregate data via the network.

5. The method according to claim 4, wherein the determining-aggregate-data step includes producing image data of a visual representation of the aggregate data.

6. The method according to claim 1, further including, before the receiving-request step, transmitting an electronic message via the network, the electronic message including a hyperlink including the askee identification data, wherein the receiving-request step includes receiving network data corresponding to access of the hyperlink.

7. A method of conducting a survey of an askee, the survey relating to a plurality of events, the method comprising automatically performing the following steps using a processor:
a) receiving data of a first event criterion from a server and storing the data of the first event criterion in a memory;
b) receiving data from a monitoring subsystem;
c) using the processor, automatically determining whether the data satisfy the first event criterion and, if so:
i) presenting a first survey question corresponding to the askee via an output device;
ii) receiving a response to the first survey question via an input device;
iii) transmitting the response to the server; and
iv) repeating the above steps, wherein data of a second event criterion are received and used in place of the first event criterion, and a second, different survey question corresponding to the askee is used in place of the first survey question.

8. The method according to claim 7, wherein the first event criterion relates to proximity to a wireless transmitter having a specified identification value and the monitoring subsystem includes a receiver configured to detect identification value(s) broadcast by wireless transmitter(s) and provide the detected identification value(s) as the data.

9. The method according to claim 8, wherein the processor is configured to determine that the data satisfy the first event criterion if a newly-detected one of the detected identification value(s) matches the specified identification value.

10. The method according to claim 8, wherein the processor is configured to determine that the data satisfy the first event criterion if one of the detected identification value(s) matches the specified identification value at a first time, and none of the detected identification value(s) matches the specified identification value at a second time later than the first time.

11. The method according to claim 7, wherein the first event criterion includes a selected aim timestamp, the monitoring subsystem is configured to provide a current timestamp as the data, and the processor is configured to determine that the data satisfy the first event criterion if the current timestamp is within a selected tolerance of the aim timestamp.

12. The method according to claim 7, wherein the first event criterion includes an aim location, the monitoring subsystem is configured to provide a current location as the data, and the processor is configured to determine that the data satisfy the first event criterion if the current location is within a selected tolerance of the aim location.

13. The method according to claim 7, further including, before said presenting the first survey question:
a) receiving data of a preliminary event criterion [e.g., the askee is at the counter] from a server and storing the data of the preliminary event criterion in a memory; and
b) using the processor, automatically waiting until the data satisfy the preliminary event criterion.

14. The method according to claim 13, wherein the monitoring subsystem is configured to provide the data including a current location of the monitoring subsystem and a current motion of the monitoring subsystem, the preliminary event criterion includes an aim location, and the first event criterion includes an aim motion.

15. The method according to claim 7, wherein the receiving-first-event-criterion step further includes receiving the second event criterion and storing the second event criterion in the memory, and wherein the repeating step includes retrieving the second event criterion from the memory.

16. The method according to claim 7, wherein the output device includes an electronic display.

17. The method according to claim 7, wherein the input device includes a touchscreen.

18. A data processing system, comprising:
a) a storage device configured to store data of an event criterion;
b) monitoring subsystem configured to provide monitoring data of a type specified in the event criterion; and
c) a processor coupled to the monitoring subsystem and configured to automatically determine whether the monitoring data satisfy the event criterion indicated by the stored data and, if so, to:
i) present a first survey question corresponding to the askee via an electronic display;
ii) receive a response to the first survey question from a askee via an input device;
iii) transmit the response via a network;
iv) receive data of a second event criterion different from the event criterion via the network; and
v) store the data of the second event criterion in place of the data of the first event criterion.

19. The system according to claim 18, wherein the input device includes a touch sensor associated with the electronic display.

20. The system according to claim 18, wherein the data processing system is embodied in a desktop computer, laptop computer, tablet computer, or smartphone.
